(19) United States
(12) Patent Application Publication
(10) Pub. No.: US 2016/0226831 A1
(43) Pub. Date: Aug. 4, 2016

(54) APPARATUS AND METHOD FOR PROTECTING USER DATA IN CLOUD COMPUTING ENVIRONMENT

(71) Applicant: ELECTRONICS AND TELECOMMUNICATIONS RESEARCH INSTITUTE, Daejeon (KR)

(72) Inventors: HongSung KIM, Daejeon (KR); Moon Haeng CHO, Daejeon (KR); Jae Min PARK, Daejeon (KR); Cheol Oh KANG, Daejeon (KR)

(21) Appl. No.: 14/832,453

(22) Filed: Aug. 21, 2015

(30) Foreign Application Priority Data
Jan. 30, 2015 (KR) 10-2015-0014699

(51) Int. Cl. H04L 29/06; H04L 29/08

(52) U.S. Cl. CPC H04L 63/0428; H04L 67/02

(57) ABSTRACT

An apparatus and method for protecting user data are disclosed herein. The apparatus for protecting user data includes a network filter, a user authentication unit, a message relay unit, and a key management unit. The network filter filters traffic between a user and a cloud server. The user authentication unit registers and authenticates the user. The message relay unit relays a message and data included in the traffic between the user and the cloud server. The key management unit generates and manages a key required to encrypt the data.

### CROSS-REFERENCE TO RELATED APPLICATION

This application claims the benefit of Korean Patent Application No. 10-2015-0014699, filed Jan. 30, 2015, which is hereby incorporated by reference herein in its entirety.

### BACKGROUND

1. Technical Field

The present disclosure relates generally to an apparatus and method for protecting user data and, more particularly, to an apparatus and method in which a gateway transparent to encryption encrypts user data to be stored in cloud storage within a cloud computing environment, thereby ensuring confidentiality and also protecting the user data from an internal threat present within a cloud system.

2. Description of the Related Art

With the activation of the markets for inexpensive Personal Computers (PCs) and smart phones, a rapidly increasing number of cloud services are being currently provided to users in the form of hosting, web hard and web services, etc.

In particular, due to the characteristics of a cloud, the duplication of data is performed. The duplication of data is problematic in that the sensitive data of users may be divulged and serious damage may be caused to individuals, companies, etc. because the duplication of data deprives the users of the control of data and internal and external threats are present.

There are two conventional methods of protecting the data of a user in a cloud environment. The first is a method of encrypting and transmitting data in a user area This method is disadvantageous in that an additional program must be installed on a user PC, and is also disadvantageous in that confidentiality cannot be completely ensured because the encryption of data does not operate transparently.

The second involves a cloud region. Even when the data of a user is encrypted, this is meaningless if a private key required encryption is divulged. If a cloud system plays a leading role in encrypting the data of a user, a problem arises in that encryption-related information may be divulged due to an internal threat within the cloud system.

Conventional technologies related to the present invention include Korean Patent Application Publication 2007-0096987 entitled “Transparent Proxy System and Packet Processing Method therefor,” and Korean Patent Application Publication 2009-0021677 entitled “Gateway-type Spam Mail Blocking System and Method transparent to Network.”

### SUMMARY

At least one embodiment of the present invention is directed to the provision of an apparatus and method for protecting user data, in which a gateway operating transparently to encryption in a user area authenticates a user accessing a cloud, and encrypts and stores data, thereby ensuring confidentiality and also supporting the mobility of a user when a plurality of gateways is present.

In accordance with an aspect of the present invention, there is provided an apparatus for protecting user data, including: a network filter configured to filter traffic between a user and a cloud server; a user authentication unit configured to register and authenticate the user; a message relay unit configured to relay a message and data included in the traffic between the user and the cloud server; and a key management unit configured to generate and manage a key required to encrypt the data.

The traffic may include the message, a data region including the data, and metadata including information about the data; and the metadata may be located before the data region.

The message may be a Hypertext Transfer Protocol (HTTP) request message.

The message relay unit may include a message header processing unit configured to process the HTTP request message, a data upload unit configured to upload data from the user to the cloud server, and a data download unit configured to transmit data, downloaded from the cloud server, to the user.

The data upload unit, when the data from the user corresponds to encryption target traffic, may read the uploaded data, may analyze the data region which becomes an encryption target, and may perform an encryption operation.

The data upload unit may perform the encryption operation based on the analysis of the data region in such a way as to distinguish the data within the data region and the metadata from each other, may encrypt the data within the data region, may reassemble the encrypted data and the metadata, and then may transmit the reassembled data to the cloud server.

The data upload unit may include a determination unit configured to determine whether the uploaded data corresponds to encryption target traffic, and an encryption unit configured to encrypt the uploaded data if the uploaded data corresponds to the encryption target traffic.

The determination unit may determine whether the uploaded data corresponds to encryption target traffic by analyzing various fields generated by parsing the HTTP request message.

The data download unit may include a determination unit configured to determine whether the downloaded data corresponds to decryption target traffic, and a decryption unit configured to decrypt the downloaded data if the downloaded data corresponds to decryption target traffic.

The message relay unit may include a proxy server configured to operate transparently to the user, and may establish a Transmission Control Protocol (TCP) session between the user and the cloud server in both directions.

The key required for the encryption may be a private key encrypted via an encryption algorithm based on the password of the user.

The key management unit may share the key required for the encryption in order to support the mobility of the user even when the user moves from his or her own network region to another network region.

The user authentication unit may issue an identification (ID) based on the user account information of the user, may generate an encryption session including information about user authentication and information about the key required for the encryption, and may transfer the encryption session to the message relay unit.

In accordance with another aspect of the present invention, there is provided a method of protecting user data, including: relaying, by a message relay unit, a message between a cloud server and a user; authenticating, by a user authentication unit, the user; encrypting, by the message relay unit, data from the user based on a key required to encrypt data and transmitting, by the message relay unit, the encrypted data to the cloud server.

The message may be included in traffic relayed between the cloud server and the user, the traffic may include the message, a data region including the data, and metadata including information about the data, and the metadata may be located before the data region.

The encrypting may include: determining whether the data from the user corresponds to encryption traffic; and if the data from the user corresponds to encryption traffic, reading the data from the user, analyzing the data region which becomes an encryption target, and performing an encryption operation.

Performing the encryption operation may include distinguishing the data within the data region and the metadata, encrypting the data within the data region, reassembling the encrypted data and the metadata, and transmitting the reassembled data to the cloud server.

The method may further include decrypting, by the message relay unit, data from the cloud server based on the key required to encrypt data, and transmitting, by the message relay unit, the decrypted data to the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram showing a system to which an apparatus for protecting user data according to an embodiment of the present invention has been applied;

FIG. 2 is a diagram showing the internal configuration of the gateway shown in FIG. 1;

FIG. 3 is a diagram showing the structure of the encryption region of a file uploaded to the cloud server shown in FIG. 1;

FIG. 4 is a conceptual diagram showing a method of ensuring the mobility of a user according to an embodiment of the present invention;

FIG. 5 is a conceptual diagram showing a method in which a guest gateway finds a home gateway in a system to which an apparatus for protecting user data according to an embodiment of the present invention has been applied;

FIG. 6 is a flowchart showing an overview of a method of protecting user data according to an embodiment of the present invention;

FIG. 7 is a flowchart showing the process of relaying a message between a user and a cloud server in a method of protecting user data according to an embodiment of the present invention;

FIG. 8 is a flowchart showing the process of determining cloud traffic and authenticating a user in a method of protecting user data according to an embodiment of the present invention;

FIG. 9 is a flowchart showing the process of encrypting use data in order to ensure the confidentiality of the user data in a method of protecting user data according to an embodiment of the present invention;

FIG. 10 is a flowchart showing the process of decrypting encrypted user data in a method of protecting user data according to an embodiment of the present invention;

FIG. 11 is a flowchart showing the process of performing user authentication in an environment in which a plurality of gateways is used according to an embodiment of the present invention;

FIG. 12 is a flowchart showing the process of registering a user according to an embodiment of the present invention; and

FIG. 13 is a diagram showing a computer system in which an embodiment of the present invention has been implemented.

### DETAILED DESCRIPTION

The present invention may be modified in various ways and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and are not used to limit the present invention. A singular form may include a plural form unless otherwise defined. The terms, including “comprise,” “includes,” “comprising,” “including” and their derivatives, specify the presence of described shapes, numbers, steps, operations, elements, parts and/or groups thereof, and do not exclude the possibility of the presence or addition of one or more other shapes, numbers, steps, operations, elements, parts, and/or groups thereof.

Unless otherwise defined herein, all terms including technical or scientific terms used herein have the same meanings as commonly understood by those skilled in the art to which the present invention pertains. It will be further understood that terms, such as those defined in commonly used dictionaries, should be interpreted as having meanings that are consistent with their meanings in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

The present invention puts emphasis on the idea that the data of a user can be efficiently and securely protected when encryption/decryption is performed in a subscriber region via a gateway that can access a cloud system. The gateway is located at the front end of a network, and operates in the form of a transparent-mode proxy server. The proxy server that operates in transparent mode is characterized in that it operates without requiring separate settings from a user, and examines all passing packets up to the application level and applies various policies, thereby supporting traffic monitoring, firewall and NAT functions, and the like.

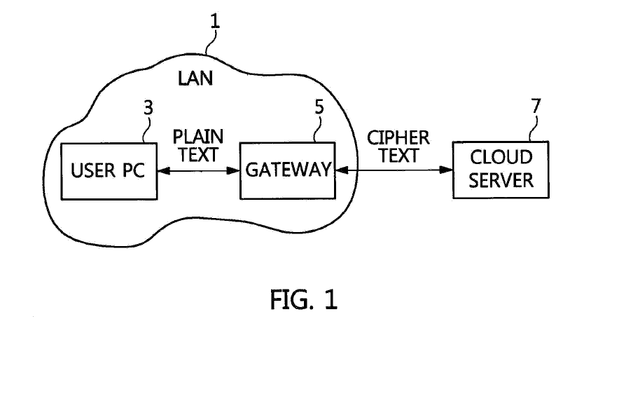

FIG. 1 is a conceptual diagram showing a system to which an apparatus for protecting user data according to an embodiment of the present invention has been applied. FIG. 1 shows the structure of a system that is formed via a user PC 3 and a cloud server 7 around a gateway 5 that is present in a user area 1 and that is transparent to encryption. The gateway 5 shown in FIG. 1 may be viewed as an apparatus for protecting user data according to an embodiment of the present invention.

Data exchanged between the user PC 3, accessing the cloud server 7, and the gateway 5 is plain text.

However, data exchanged between the gateway 5 and the cloud server 7 is encrypted and then transmitted and received. This means that original plain text data cannot be obtained without using the gateway 7 that is present in the user area 1.

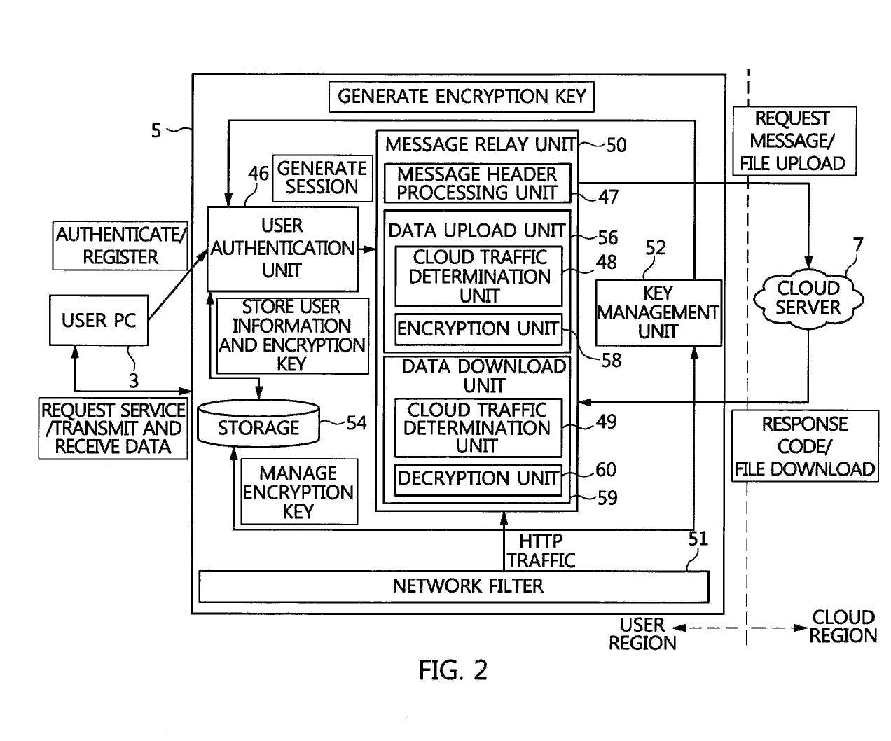

FIG. 2 is a diagram showing the internal configuration of the gateway 5 shown in FIG. 1.

The gateway 5 includes a network filter 51, a user authentication unit 46, a message relay unit 50, a key management unit 52, and storage 54.

The network filter 51 may filter traffic so that an HTTP message can be relayed.

The user authentication unit 46 may register and authenticate a user.

The message relay unit 50 may relay a message and data generated between the user PC 3 and the cloud server 7.

The key management unit 52 may generate and manage a key (for example, a private key) required to encrypt the user's data.

Meanwhile, to support the mobility of the user across environments present in a plurality of gateways, the key management unit 52 may manage and share a private key required for encryption.

The storage 54 may store information generated by the user authentication unit 46, the message relay unit 50 and the key management unit 52.

Since the user basically accesses the cloud server 7 via the Web, the gateway 5 filters web traffic via the network filter 51 and provides the filtered web traffic to the message relay unit 50, and other traffic is basically controlled in accordance with a basic network policy.

In this case, the user authentication unit 46 is responsible for registering and authenticating the user so that the user can access the cloud server 7 via the user PC 3 and the gateway 5. Upon initial registration, the user authentication unit 46 generates a key required for encryption via the key management unit 52, receives an ID and a password user, and stores them in the storage 54. In this case, the private key is encrypted via a password-based encryption algorithm, and is securely stored. As a result, the authenticated user may transmit session information, including authentication information and the key required for encryption, to the message relay unit 50, thereby allowing the user PC 3 to access the cloud server 7 and also allowing data to be encrypted.

Furthermore, the message relay unit 50 (which may be a proxy server) may operate transparently to the user, and ma implement various functions while relaying traffic because a TCP session is established between the user PC 3 and the cloud server 7 in both directions. In the system to which an embodiment of the present invention has been applied, a proxy server present in the form of a gateway encrypts user data transmitted to the cloud server 7, thereby ensuring the confidentiality of the user data within a cloud computing environment.

Meanwhile, the message relay unit 50 includes a message header processing unit 47, a data upload unit 56, and a data download unit 59.

The message header processing unit 47 may process an HTTP request message, the data upload unit 56 may process upload data, and the data download unit 59 may process downloaded data.

The data upload unit 56 includes a cloud traffic determination unit 48 configured to determine whether data uploaded to the cloud server 7 is encryption target traffic, and an encryption unit 58 configured to encrypt the uploaded data if the uploaded data is encryption target traffic. In this case, the cloud traffic determination unit 48 may be viewed as an encryption target traffic determination unit.

The data download unit 59 includes a cloud traffic determination unit 49 configured to determine whether data downloaded from the cloud server 7 is a decryption target traffic, and a decryption unit 60 configured to decrypt the downloaded data if the downloaded is decryption target traffic. In this case, the cloud traffic determination unit 49 may be viewed as a decryption target traffic determination unit.

All messages and data generated when the user accesses the cloud server 7 pass through the message relay unit 50. First, the message relay unit 50 temporarily stores an HTTP request message, entering via the message header processing unit 47, in memory, obtains cloud server information from the request message, and then establishes a TCP session with the cloud server 7. Thereafter, the message relay unit 50 transmits the stored original message (that is, HTTP request message) to the cloud server 7, thereby being responsible for the relay of messages between the user PC 42 and the cloud server 7.

In addition to the request message, the user uploads or downloads a file. The cloud traffic determination unit 48 determines whether to encrypt the received data traffic by determining whether the received data traffic is cloud access traffic. If the received data traffic is encryption target traffic, the cloud traffic determination unit 48 obtains the private key of the user from the session information received from the user authentication unit 46, encrypts the data of the received data traffic, and transfers the encrypted data to the cloud server 7. In contrast, the cloud traffic determination unit 48 decrypts data received from the cloud server 7, and then transmits the decrypted data to the user PC 3.

The key management unit 52 functions to generate and manage a key required for encryption. The private key generated for encryption has a life cycle in any form, which ensures the security of the private key.

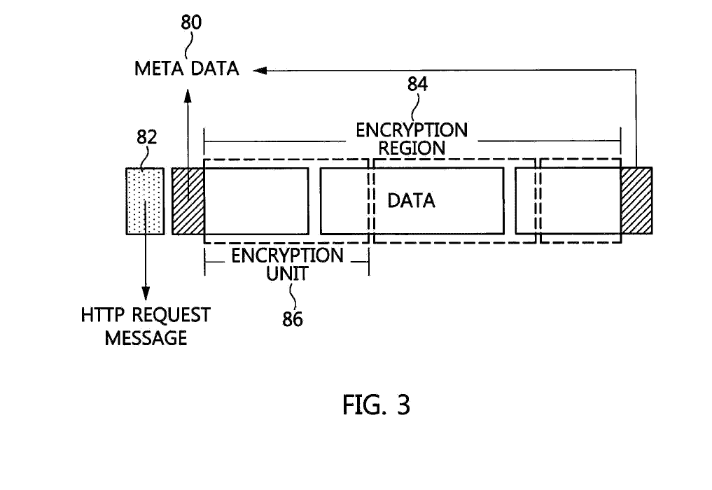

FIG. 3 is a diagram showing the structure of the encryption region of a file uploaded to the cloud server 7 shown in FIGS. 1 and 2.

Traffic uploaded from the message relay unit 50 of the gateway 5 via HTTP is divided into an HTTP request message 82 and a data region.

When data is uploaded, metadata 80 including the information (for example, a file name, a file size, etc.) of a file is included in the data and then transmitted. Accordingly, a region that is an actual encryption target is a region 84 that is interposed between two pieces of metadata 80. Furthermore, since an encryption operation is processed on a block basis, data corresponding to the encryption region 84 is processed on a per-encryption unit 86.

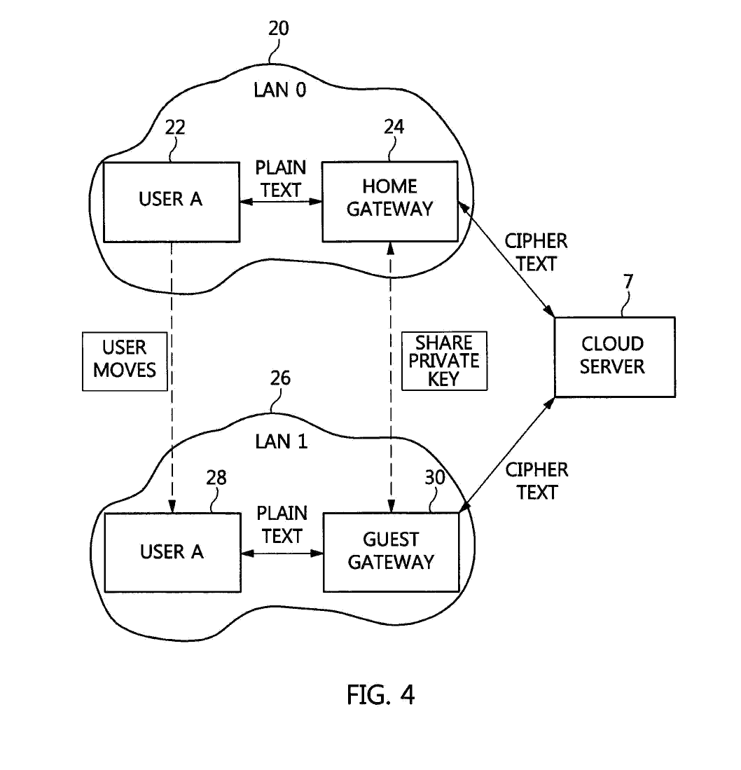

FIG. 4 is a conceptual diagram showing a method of ensuring the mobility of a user according to an embodiment of the present invention. That is, FIG. 4 is a conceptual diagram showing a method of ensuring the mobility of a user in an environment in which a plurality of gateways 24 and 30 are present.

A user A 22 may move to another network region 26 while using service via the home gateway 24 within his or her own network region 20. From the standpoint of the user A 22, a gateway present in the LAN0 20 acts as a home gateway, and a gateway present in the LAN1 26 acts as a guest gateway. These gateways are distinguished from each other depending on whether the account information and private key of the user are present in a local region.

When the user A present in the LAN0 20 moves to the LAN1 26, the user A 28 requests private key information from his or her own home gateway 24 in order to access the cloud server 7 via the guest gateway 30 that is used by him or her In this case, since a request process includes a user authentication process, private key information encrypted based on a password is received if authentication is successful. The authenticated user A 28 may obtain an encrypted private key via his or her password, and may finally transmit ciphertext to the cloud server 7.

In FIG. 4, although the user A 22 and the user A 28 have different reference numerals, they are the same user. Since the network regions are simply different, reference numerals are assigned.

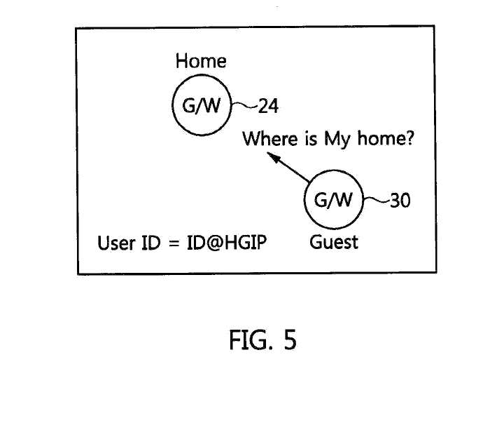

FIG. 5 is a conceptual diagram showing a method in which a guest gateway finds a home gateway in a system to which an apparatus for protecting user data according to an embodiment of the present invention has been applied.

When the user A 22 moves from LAN0 20 to LAN1 26, the sharing of a private key can be requested only when the guest gateway 30 knows the home gateway information of the user A 28.

However, due to the characteristic of a gateway in which the gateway operates transparently a user, it is necessary to naturally become aware of home gateway information. For this purpose, the structure of the ID of the initial user A is issued in the form of “ID@HGIP” (a home gateway IP address), so that it may be possible to obtain its own home gateway information from the user ID even when any gateway makes access to a cloud, with the result that the sharing of a private key may be attempted.

Meanwhile, a method of protecting user data according to an embodiment of the present invention is as follows.

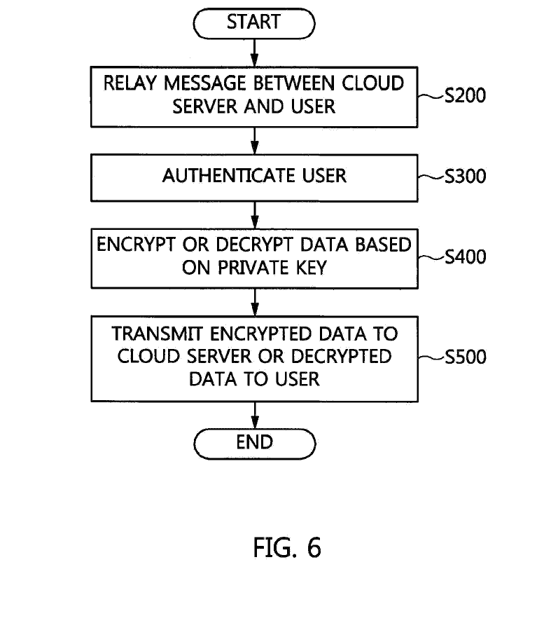

The method of protecting user data according to the present embodiment, as shown in FIG. 6, includes step S200 of relaying a message between the cloud server 7 and a user; step S300 of authenticating the user who is accessing the cloud server 7; step S400 of encrypting or decrypting data based on a key intended for the encryption of the data; and step S500 of transmitting the encrypted data to the cloud server 7 or transmitting the decrypted data to the user.

In the following, the method of protecting user data according to the present embodiment is described in greater detail.

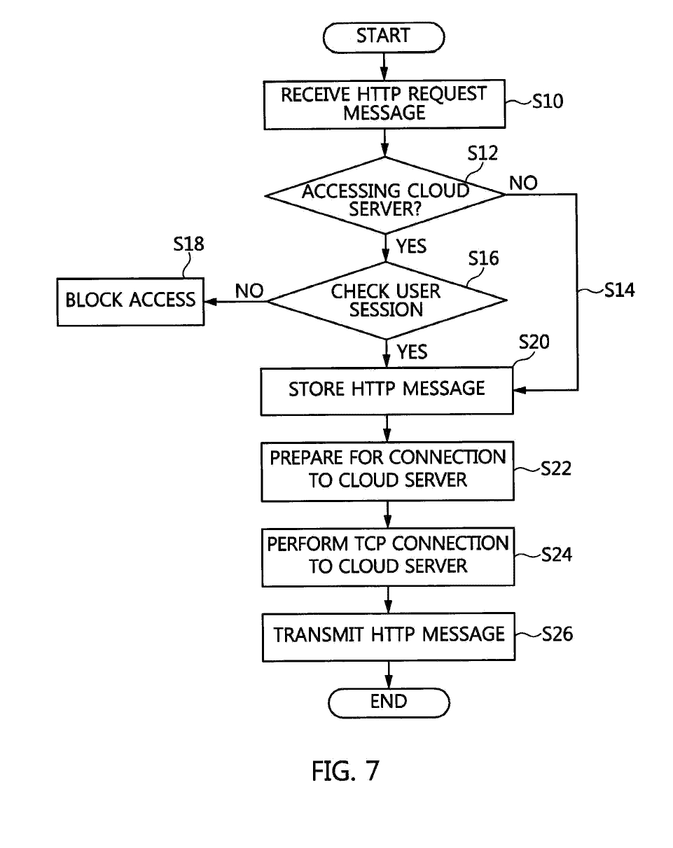

FIG. 7 is a flowchart showing the process of relaying a message between a user and a cloud server in a method of protecting user data according to an embodiment of the present embodiment.

When the gateway 5 receives an HTTP request message from the user PC 3 at step S10, the gateway 5 determines whether a user is accessing the cloud server 7 via the fields of a URL, etc. first at step S12.

If, as a result of the determination, the received request message does not correspond to a cloud access request, a message relay process is performed at step S14. In contrast, if the user is accessing the cloud server 7, it is determined whether the encryption session of the accessing user is present at step S16.

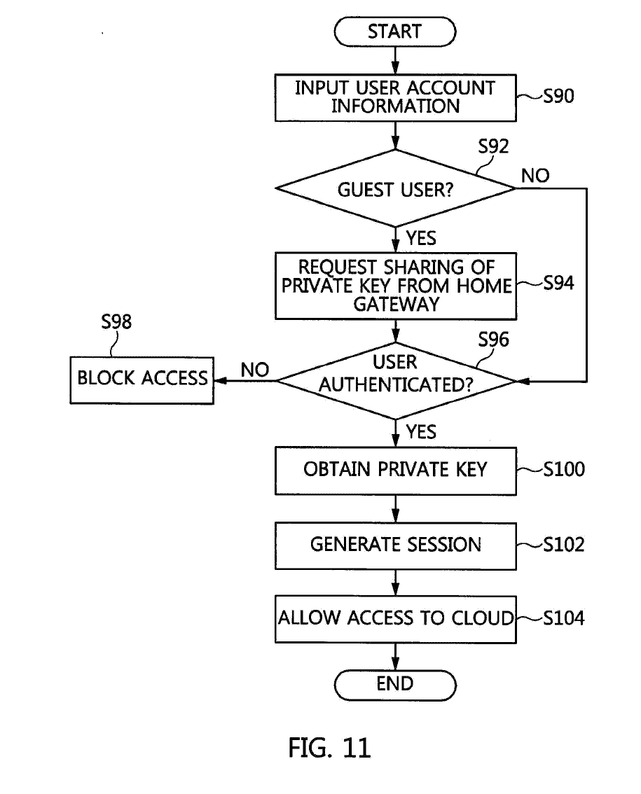

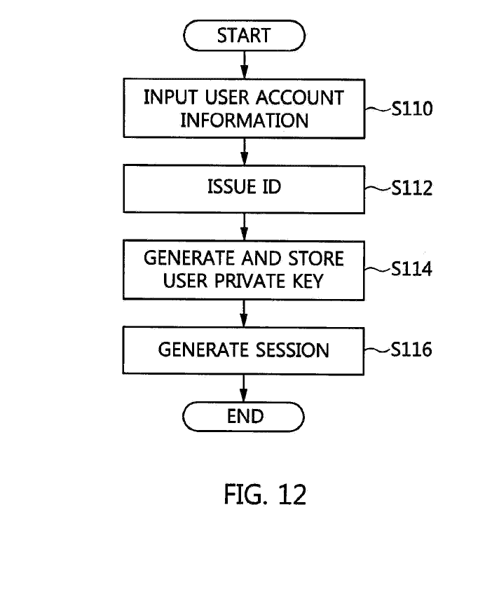

If there is no encryption session of the accessing user, the gateway 5 blocks access to the cloud at step S18, and performs a user authentication process. A user authentication process in the case where an existing account is present will be easily understood by referring to FIG. 11. The process of registering a new account will be easily understood by referring to FIG. 12.

If the encryption session of the accessing user is present, a message relay process is performed. In a detailed message relay process, first, the gateway 5 temporarily stores an HTTP request message in memory, for example, the storage 54, at step S20. Thereafter, the gateway 5 prepares for a TCP connection to the cloud server 7 via request message information at step S22, and establishes a TCP connection to the cloud server 7 via collected information at step S24. Finally, the gateway 5 transmits the HTTP request message temporarily stored in the memory to the cloud server 7 at step S26.

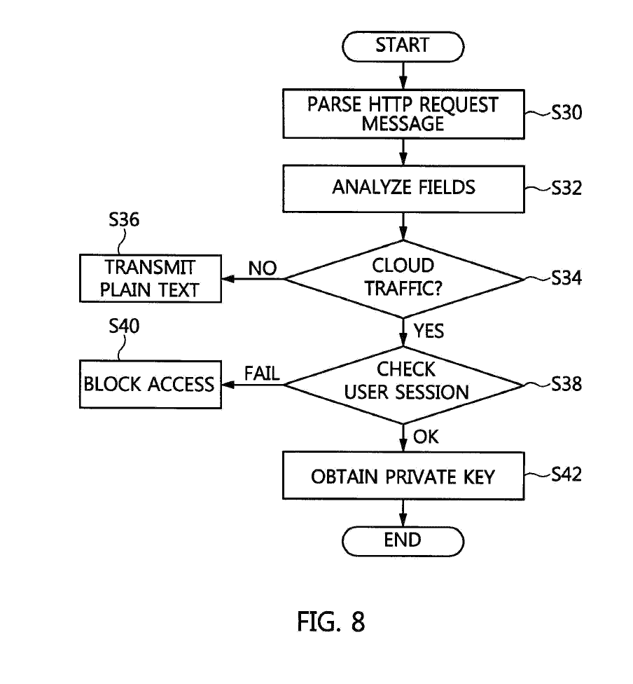

FIG. 8 is a flowchart showing the process of determining cloud traffic and authenticating a user in a method of protecting user data according to an embodiment of the present invention.

In the gateway 5, data traffic entering via the message relay unit 50 is processed via the data upload unit 56 or data download unit 59. In order to avoid the encryption and decryption of HTTP data traffic, it is determined whether the entering traffic is traffic that is accessing the cloud server 7. For this purpose, the cloud traffic determination unit of the data upload unit 56 or data download unit 59 of the gateway 5 parses the HTTP request message at step S30, and then analyzes various fields at step S32. By doing so, it may be determined whether the entering traffic is cloud traffic.

If the entering traffic is not cloud traffic (“No” at S34), the gateway 5 transmits data in the form of plain text at step S36.

In contrast, if the entering traffic is not cloud traffic (“Yes” at S34), the gateway 5 determines whether the encryption session of the authenticated user is present at step S38.

If the encryption session of the authenticated user is not present, the gateway 5 blocks access to the cloud server 7 at step S40. In contrast, if the encryption session of the authenticated user is present, a user private key is obtained and used for an encryption operation at step S42.

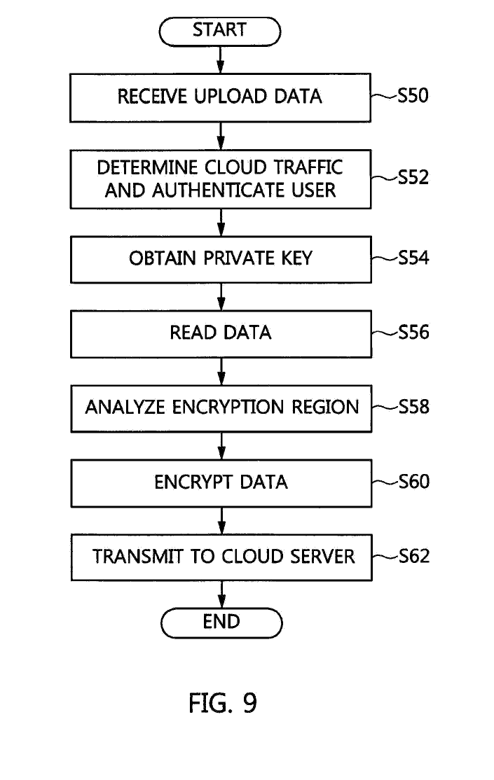

FIG. 9 is a flowchart showing the process of encrypting use data in order to ensure the confidentiality of the user data in a method of protecting user data according to an embodiment of the present invention.

When the data upload unit 56 receives data that is used when a user uploads a file to the cloud server 7 at step S50, the data upload unit 56 determines whether traffic in question is cloud traffic and also determines whether the encryption session of the user is present in order to determine whether to perform encryption at step S52. A method of determining whether traffic in question is cloud traffic has been described with reference to FIG. 7.

If traffic in question is cloud traffic (for example, encryption target traffic) and the encryption session of the user is present, the data upload unit 56 obtains the private key of the user and prepares for an encryption operation at step S54.

Thereafter, the data upload unit 56 reads uploaded data at step S56, and analyzes an encryption target region at step S58. In this case, a method of analyzing the encryption target region divides the encryption target region into actual encryption target file data and metadata 80, as described in FIG. 3. Since the file data is reassembled after encryption, the metadata 80 is temporarily stored in memory. Since encryption is basically performed on a block basis, data corresponding to the encryption region 84 is stored in a buffer and read to the encryption unit 86, and then an actual encryption operation is performed at step S60. Finally, to transmit the encrypted data to the cloud server 7, the data upload unit 56 reassembles the encrypted data and the metadata 80 previously stored in the memory, and then transmits the assembled data to the cloud server 7 at step S62.

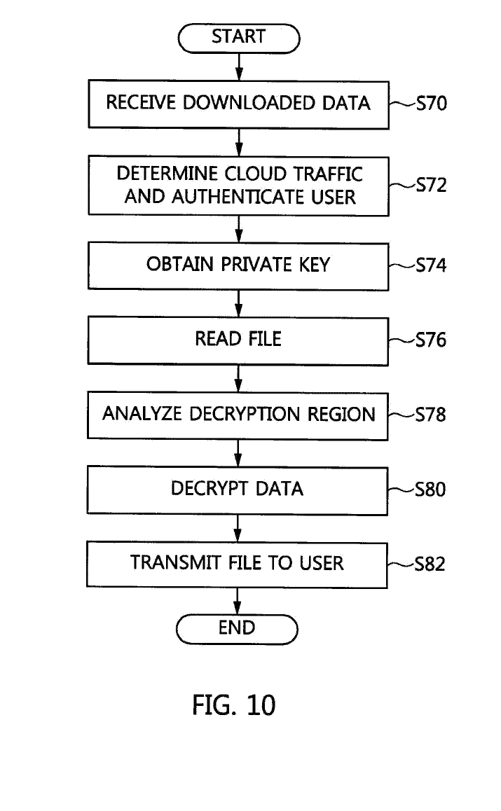

FIG. 10 is a flowchart showing the process of decrypting encrypted user data in a method of protecting user data according to an embodiment of the present invention. This process is similar to the encryption flow described with reference to FIG. 9.

That is, when the data download unit 59 downloads a file, i.e., receives downloaded data, from the cloud server 7 at step S70, the data download unit 59 determines whether traffic in question is cloud traffic and also determines whether the encryption session of the user is present in order to determine whether to perform decryption at step S72. A method of determining whether traffic in question is cloud traffic has been described with reference to FIG. 7.

If traffic in question is cloud traffic (for example, encryption target traffic) and the encryption session of the user is present, the data download unit 59 obtains the private key of the user and prepares for a decryption operation at step S74.

Thereafter, the data download unit 59 reads downloaded data at step S76, and analyzes a decryption target region at step S78. In this case, a method of analyzing the decryption target region has been described with reference to FIG. 3. Accordingly, the encryption region 84 of FIG. 3 corresponds to a decryption region. Since decryption is basically performed on a block basis, data corresponding to the decryption region is stored on a decryption unit basis (for example, on an encryption unit (86) basis), and then an actual decryption operation is performed at step S80. Finally, to transmit the decrypted data to the user PC 3, the data download unit 59 reassembles the decrypted data and the metadata 80 previously stored in the memory, and then transmits the assembled data to the user PC 3 at step S82.

FIG. 11 is a flowchart showing the process of performing user authentication in an environment in which a plurality of gateways is used according to an embodiment of the present invention.

First, the gateway of a plurality of gateways that is currently accessed by a user receives account information from the user at step S90.

Thereafter, as shown in FIG. 5, the IP address of the home gateway 24 is extracted from a user ID and is compared with the IP address of a current gateway at step S92.

If these IP addresses are different from each other, the guest gateway 30 is used, the gateway (which may be the guest gateway 30) that is currently accessed by the user home requests the sharing of a private key from the gateway 24 in order to obtain the private key required for an encryption operation at step S94.

Thereafter, a user authentication process is performed. In this case, the user of a guest gateway is authenticated by the home gateway 24 and the user of a home gateway is authenticated by the gateway currently accessed by the user of the home gateway at step S96.

If the authentication fails (“No” at step S96), the gateway currently accessed by the user blocks access to the cloud server 7 at step S98.

In contrast, if the authentication successes, the gateway currently accessed by the user obtains a user private key at step S100, and generates a session and transfers data to the message relay unit 50 at step S102.

Finally, after the authentication has been terminated, the user may access the cloud server 7 at step S104.

FIG. 12 is a flowchart showing the process of registering a user according to an embodiment of the present invention.

A user must generate an account via the gateway 5 in order to use an encryption service. This process occurs when the user accesses the gateway 5 first.

When the user inputs user account information at step S110, the user authentication unit 46 within the gateway 5 issues an ID in the form of “ID@HGIP” at step S112, and generates a private key required for encryption via the key management unit 52 and stores the private key in the storage 54 at step S114.

Finally, the user authentication unit 46 generates an encryption session including information about user authentication and private key information required for an encryption operation and transfers the encryption session to the message relay unit 50 at step S116.

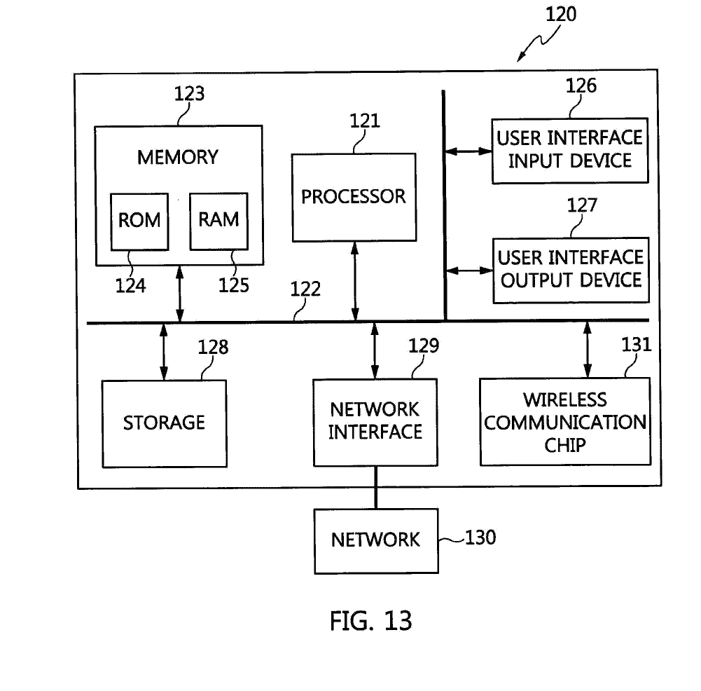

Meanwhile, the above-described embodiment of the present invention may be implemented in a computer system, such as a computer-readable recording medium. As shown in FIG. 13, a computer system 120 may include at least one processor 121, memory 123, a user interface input device 126, a user interface output device 127, and storage 128, which communicate with each other over a bus 122. Furthermore, the computer system 120 may include one or more network interfaces 129 connected to the network 130. The processor 121 may be a central processing unit or a semiconductor device that executes processing instructions stored in the memory 123 or storage 128. The memory 123 and the storage 128 may be various types of volatile or nonvolatile storage media. For example, the memory 123 may include ROM 124 or RAM 125.

Furthermore, in the case where the computer system 120 is implemented as a small-sized computing device in preparation for the Internet of Things (IoT) era, when an Ethernet cable is connected to the computing device, the computing device operates as a wireless sharer, a mobile device may be wirelessly connected to a gateway, and the computing device may perform encryption and decryption functions. For this purpose, the computer system 120 may include a wireless communication chip (a WiFi chip) 131.

Accordingly, an embodiment of the present invention may be implemented as a non-transient computer-readable medium in which a computer implemented method or computer executable instructions are stored. When computer-readable instructions are executed by a processor, the computer-readable instructions may perform a method according to at least one embodiment of the present invention.

According to the present invention having the above configuration, a gateway provides transparency to a user without the encryption-related separate settings of the user, so that the reading and writing of an original file can be performed.

Furthermore, the data of a user is encrypted and then stored, so that the data of the user can be securely protected from an internal threat present within a cloud system.

Furthermore, a private key is shared between a plurality of gateways, so that a user can access his or her own file present within a cloud even when using a gateway present in another area.

Although the conventional method of performing encryption in a user area has the possibility of bypassing encryption and also requires additional settings and a program from a user, the method using a gateway according to the present invention operates transparently without the interference of the user, so that a bypass path can be blocked.

Furthermore, although the conventional method of performing encryption within a cloud region is still exposed to an internal threat because a private key required for encryption is managed within a cloud region, the gateway of the present invention encrypts the private key information of a user and stores the encrypted private key in the internal storage, so that the data of the user can be securely protected from an internal threat within a cloud system.

As described above, the exemplary embodiments have been disclosed in the present specification and the accompanying drawings. Although the specific terms have been used herein, they have been used merely for the purpose of describing the present invention, but have not been used to restrict the meanings thereof or limit the scope of the present invention set forth in the attached claims. Accordingly, it will be appreciated by those having ordinary knowledge in the relevant technical field that various modifications and other equivalent embodiments can be made. Therefore, the true range of protection of the present invention should be defined based on the technical spirit of the attached claims.

What is claimed is:

1. An apparatus for protecting user data, comprising:
a network filter configured to filter traffic between a user and a cloud server;
a user authentication unit configured to register and authenticate the user;
a message relay unit configured to relay a message and data included in the traffic between the user and the cloud server; and
a key management unit configured to generate and manage a key required to encrypt the data.

2. The apparatus of claim 1, wherein:
the traffic comprises the message, a data region including the data, and metadata including information about the data; and
the metadata is located before the data region.

3. The apparatus of claim 2, wherein the message is a Hypertext Transfer Protocol (HTTP) request message.

4. The apparatus of claim 3, wherein the message relay unit comprises:
a message header processing unit configured to process the HTTP request message;
a data upload unit configured to upload data from the user to the cloud server; and
a data download unit configured to transmit data, downloaded from the cloud server, to the user.

5. The apparatus of claim 4, wherein the data upload unit, when the data from the user corresponds to encryption target traffic, reads the uploaded data, analyzes the data region which becomes an encryption target, and performs an encryption operation.

6. The apparatus of claim 5, wherein the data upload unit performs the encryption operation based on the analysis of the data region in such a way as to distinguish the data within the data region and the metadata from each other, encrypt the data within the data region, reassemble the encrypted data and the metadata, and then transmit the reassembled data to the cloud server.

7. The apparatus of claim 4, wherein the data upload unit comprises:
a determination unit configured to determine whether the uploaded data corresponds to encryption target traffic; and
an encryption unit configured to encrypt the uploaded data if the uploaded data corresponds to the encryption target traffic.

8. The apparatus of claim 7, wherein the determination unit determines whether the uploaded data corresponds to encryption target traffic by analyzing various fields generated by parsing the HTTP request message.

9. The apparatus of claim 4, wherein the data download unit comprises:
a determination unit configured to determine whether the downloaded data corresponds to decryption target traffic; and
a decryption unit configured to decrypt the downloaded data if the downloaded data corresponds to decryption target traffic.

10. The apparatus of claim 1, wherein the message relay unit comprises a proxy server configured to operate transparently to the user, and establishes a Transmission Control Protocol (TCP) session between the user and the cloud server in both directions.

11. The apparatus of claim 1, wherein the key required for the encryption is a private key encrypted via an encryption algorithm based on a password of the user.

12. The apparatus of claim 1, wherein the key management unit shares the key required for the encryption in order to support mobility of the user even when the user moves from his or her own network region to another network region.

13. The apparatus of claim 1, wherein the user authentication unit issues an identification (ID) based on user account information of the user, generates an encryption session including information about user authentication and information about the key required for the encryption, and transfers the encryption session to the message relay unit.

14. A method of protecting user data, comprising:
relaying, by a message relay unit, a message between a cloud server and a user;
authenticating, by a user authentication unit, the user;
encrypting, by the message relay unit, data from the user based on a key required to encrypt data; and
transmitting, by the message relay unit, the encrypted data to the cloud server.

15. The method of claim 14, wherein:
the message is included in traffic relayed between the cloud server and the user; and
the traffic includes the message, a data region including the data, and metadata including information about the data, and the metadata is located before the data region.

16. The method of claim 15, wherein the encrypting comprises:
determining whether the data from the user corresponds to encryption traffic; and
if the data from the user corresponds to encryption traffic, reading the data from the user, analyzing the data region which becomes an encryption target, and performing an encryption operation.

17. The method of claim 16, wherein performing the encryption operation comprises distinguishing the data within the data region and the metadata, encrypting the data within the data region, reassembling the encrypted data and the metadata, and transmitting the reassembled data to the cloud server.

18. The method of claim 14, further comprising:
decrypting, by the message relay unit, data from the cloud server based on the key required to encrypt data; and
transmitting, by the message relay unit, the decrypted data to the user.

19. The method of claim 14, wherein the key required to encrypt the data is shared in order to support mobility of the user as the user moves from his or her own network region to another network region.

20. The method of claim 19, wherein the key required for the encryption is a private key encrypted via an encryption algorithm based on a password of the user.
